(19) United States
(12) Patent Application Publication
(10) Pub. No.: US 2021/0042871 A1
(43) Pub. Date: Feb. 11, 2021

(54) MESH NETWORK FOR PARENT-CHILD PACKAGE MONITORING

(71) Applicant: United Parcel Service of America, Inc., Atlanta, GA (US)

(72) Inventors: Carl M. Skonberg, Wyckoff, NJ (US); Ted Abebe, Jersey City, NJ (US); Daniel Paul Tyler, Louisville, KY (US)

(21) Appl. No.: 16/984,327

(22) Filed: Aug. 4, 2020

Related U.S. Application Data
(60) Provisional application No. 62/882,718, filed on Aug. 5, 2019.

(51) Int. Cl. G06Q 50/28; G06Q 30/00; H04W 4/029

(52) U.S. Cl. CPC G06Q 50/28; H04W 84/18; H04W 4/029; G06Q 30/0185

(57) ABSTRACT

Embodiments herein provide a system and method for generating mobile mesh networks that monitor multi-package shipments. In embodiments, mobile mesh networks are created using a plurality of devices that are associated with and travel with packages in a multi-package shipment. The plurality of devices are configured to form a mesh network: some devices act as child nodes and at least one device acts as a parent node. In embodiments, the devices acting as child nodes provide information to the device acting as the parent node through the mesh network. Then, the device acting as the parent node provides information to an external device for monitoring purposes. As such, a portion or all of the packages in a multi-package shipment are monitored using the device acting as the parent node as a proxy for the packages in the multi-package shipment.

### CROSS REFERENCE TO RELATED APPLICATIONS

The present application is a nonprovisional application that claims the benefit of and priority to U.S. Provisional Application No. 62/882,718, filed Aug. 5, 2019, which is incorporated herein by reference in its entirety.

### BACKGROUND

With the increasing demand for complete visibility in global scale package monitoring, new technologies are needed that create omniscient visibility in packing, shipping, and delivery chains.

### BRIEF SUMMARY

In general, embodiments of the present invention provide a system and method for generating mobile mesh networks that monitor multi-package shipments. As discussed hereinafter, the system and method create multiple mobile mesh networks using a plurality of devices that are co-located and which travel with packages in a multi-package shipment. In this way, the system and method monitor and track packages at a ratio that is greater than 1:1, i.e., a plurality of the packages in a multi-package shipment may be monitored and tracked through one device that is acting as the primary node in the mesh network, where the remainder of devices in the mesh network act as secondary nodes.

In one embodiment, one or more computer-readable storage media storing computer-usable instructions are provided that, when used by a computing device, cause the computing device to perform a method. In an embodiment, the method identifies a first device and a second device. The method designates the first device to be a primary node in a mesh network, and further, designates the second device to be a secondary node in the mesh network, wherein the secondary node is monitored by the primary node over the mesh network, in some embodiments. The method continues by electronically linking the first device to a first shipping label in a plurality of shipping labels, wherein the plurality of shipping labels correspond to a multi-package shipment comprising a plurality of packages, and wherein the first device is attached to a first package in the multi-package shipment. In embodiments, the second device is electronically linked to a second shipping label in the plurality of shipping labels, wherein the second device is attached to a second package in the multi-package shipment. The method comprises monitoring the multi-package shipment based on the first device that is designated as the primary node that monitors the second device that is designated as the secondary node. In accordance with embodiments, an indication of the first device is received, wherein the indication includes location data for the first package, and includes location data for the second package received, by the first device over the mesh network, from the second device. The method determines that the first device and the second device are concurrently located at a first location in a shipping chain based on the indication, in embodiments.

In another embodiment, one or more computer-readable storage media storing computer-usable instructions are provided that, when used by a computing device, cause the computing device to perform a method. In an embodiment, the method identifies a first device and a second device. The method designates the first device to be a primary node in a mesh network, and further, designates the second device to be a secondary node in the mesh network, wherein the secondary node is monitored by the primary node over the mesh network, in some embodiments. The method continues by electronically linking the first device to a first shipping label in a plurality of shipping labels, wherein the plurality of shipping labels correspond to a multi-package shipment comprising a plurality of packages, and wherein the first device is attached to a first package in the multi-package shipment. In embodiments, the second device is electronically linked to a second shipping label in the plurality of shipping labels, wherein the second device is attached to a second package in the multi-package shipment. The method comprises monitoring the multi-package shipment based on the first device that is designated as the primary node that monitors the second device that is designated as the secondary node. In accordance with embodiments, an indication of the first device is received, wherein the indication includes location data for the first package, and indicates that the first device has not detected the second device over the mesh network. The method determines that the first device and the second device are not concurrently located at a first location in a shipping chain based on the indication of the first device, in some embodiments.

In an embodiment, one or more computer-readable storage media storing computer-usable instructions are provided that, when used by a computing device, cause the computing device to perform a method. In an embodiment, the method identifies a plurality of devices comprising at least a first device, a second device, and a third device. In some embodiments, the first device is designated to be a primary node in a mesh network formed by the plurality of devices. Additionally, the second device and the third device are designated to be secondary nodes in the mesh network, wherein the secondary nodes are monitored by the primary node over the mesh network, in embodiments. The method further electronically links the first device to a first shipping label in a plurality of shipping labels, wherein the plurality of shipping labels correspond to a multi-package shipment comprising a plurality of packages, and wherein the first device is attached to a first package in the multi-package shipment. The method also electronically links the second device to a second shipping label in the plurality of shipping labels, wherein the second device is attached to a second package in the multi-package shipment. Additionally, the method electronically links the third device to a third shipping label in the plurality of shipping labels, wherein the third device is attached to a third package in the multi-package shipment. The method continues by monitoring the first package, the second package, and the third package of the multi-package shipment based on the first device designated as the primary node of the mesh network. In some embodiments, an indication of the first device is received, wherein the indication includes location data for the first package, and indicates that the first device has not detected at least one of the second device or the third device over the mesh network. As such, in some embodiments, the first device and the at least one of the second device or the third device are determined not to be concurrently located at a first location in a shipping chain based on the indication of the first device.

In another aspect, a system is provided. The system comprises one or more computer-readable storage media storing instructions that are executable by a processor to perform a method for monitoring a multi-package shipment. The system identifies a first device and a second device. The system designates the first device to be a primary node in a mesh network, wherein the primary node communicates over the mesh network and an external network, in an embodiment. The system also designates the second device to be a secondary node in the mesh network, wherein the secondary node is monitored by the primary node over the mesh network. The system electronically links the first device to a first shipping label in a plurality of shipping labels, wherein the plurality of shipping labels correspond to a multi-package shipment comprising a plurality of packages, and wherein the first device is attached to a first package in the multi-package shipment. The system electronically links the second device to a second shipping label in the plurality of shipping labels, wherein the second device is attached to a second package in the multi-package shipment, in an embodiment. Then, the system monitors the multi-package shipment based on the first device designated as the primary node that monitors the secondary node over the mesh network, in embodiments. The system may receive an indication of the first device, wherein the indication includes location data for the first package and indicates that the first device has not detected the second device over the mesh network, in some embodiments. In one embodiment, the system determines that the first device and the second device are not concurrently located at a first location in a shipping chain based on the indication of the first device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a diagram of computing environment in accordance with an embodiment;

FIG. 2 depicts a flow chart of a method in accordance with an embodiment;

FIG. 3 depicts a flow chart of another method in accordance with an embodiment;

FIG. 4A-B depict a flow chart of yet another method in accordance with an embodiment;

FIG. 5 illustrates a diagram of a computing device, in accordance with an embodiment;

and

FIG. 6 illustrates a diagram of a computing device, in accordance with an embodiment.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step,” “instance,” and/or “block” can be used herein to connote different elements of methods or system operations employed, the terms should not be interpreted as implying any particular order among or between various steps unless and except when the order of individual steps is explicitly described. The term “or” is used herein in both the alternative and conjunctive sense, unless otherwise indicated. The terms “illustrative” and “exemplary” are used to be examples with no indication of quality level.

The present disclosure will now be described more fully herein with reference to the accompanying drawings, which may not be drawn to scale and which are not to be construed as limiting. Indeed, the present invention can be embodied in many different forms and should not be construed as limited to the embodiments set forth herein.

In embodiments herein, the physical location of a group of packages that belong to one shipment (i.e., “multi-package shipment”) are monitored and tracked using one device that travels with one of the packages in the group. The one device, for example, serves as a location and/or status proxy to one or more, or all, of the packages in the group, through some or all aspects of a packing, pick-up, shipping, and delivery, independent of the scale of the multi-package shipment (i.e., number of packages in the group) and/or the scale of the distance being traveled. For example, a multi-package shipment may be location tracked and/or environmentally monitored using one or more sensors of the “parent” device designated to act as the proxy, beginning from the creation of a shipment record for the multi-package shipment through various stages such as fulfillment and/or consolidation, loading and/or unloading of a vehicle or feeder, during transport using one or more vehicles (e.g., automobile, truck, trailer, airplane, train, package cart, unmanned vehicle, unmanned aerial vehicle), unloading, and/or through to the end-point delivery location (e.g., residential address, business address, locker, retail store) for the multi-package shipment. In one example, a multi-package shipment may be location tracked and/or environmentally monitored using one or more sensors of the “parent” device designated to act as the proxy, beginning from the creation of a shipment record for the multi-package shipment through various stages, such as an initial pick-up of the packages and “ingestion” into the carrier's system, and throughout transport using one or more vehicles to a destination location. In some embodiments, the parent device may be leveraged to monitor the multi-package shipment through a reverse cycle, i.e., a returns process. In embodiments, the parent device creates near-omniscience by providing “high resolution” or “fine grain” visibility through the entire packing, shipping, and delivery chain.

In order to create this new and improved visibility, the parent device and one or more additional devices are specially configured to create a mesh network that is specific to the multi-package shipment, in embodiments. The parent device serves as a primary node while the one or more additional devices serve as secondary nodes within the mesh network, in an embodiment. For example, the parent device and the one or more additional devices are each physically associated with separate packages in the multi-package shipment, on a one-to-one device to package ratio, such that the parent device and the one or more additional devices travel with the packages. Using the mesh network to communicate with one another and the parent device, the one or more additional devices provide near real-time information to the parent device, for example, by indicating the presence of the package by way of the corresponding device, that presence being relative to the mesh network. The parent device may then provide the consolidated information regarding a corresponding package, and the corresponding packages for each of the one or more additional devices, to a system or computing device for monitoring and tracking the multi-package shipment, in some embodiments. Accordingly, in an embodiment, only the parent device is actively monitored by a computing device or system in order to determine the location of one or more, or all, of the packages in the multi-package shipment, throughout the packing, shipping, and delivery chain.

In various embodiments, the parent device may be more sophisticated in software and/or hardware than the one or more additional devices. For example, the parent device may detect a signal from an additional device over the mesh network and the parent device may determine the package for the additional device is present. In such an example, the parent device may generate a report of a location and/or environmental information for one or more, or all, the packages in the multi-package shipment using one or more sensors of the parent device, and may provide the location data and/or environmental data captured by the parent device to an external network and/or another device, thus representing the location data and/or environmental data of the packages corresponding to the additional devices. The technological benefits and the technological improvements are further discussed hereinafter.

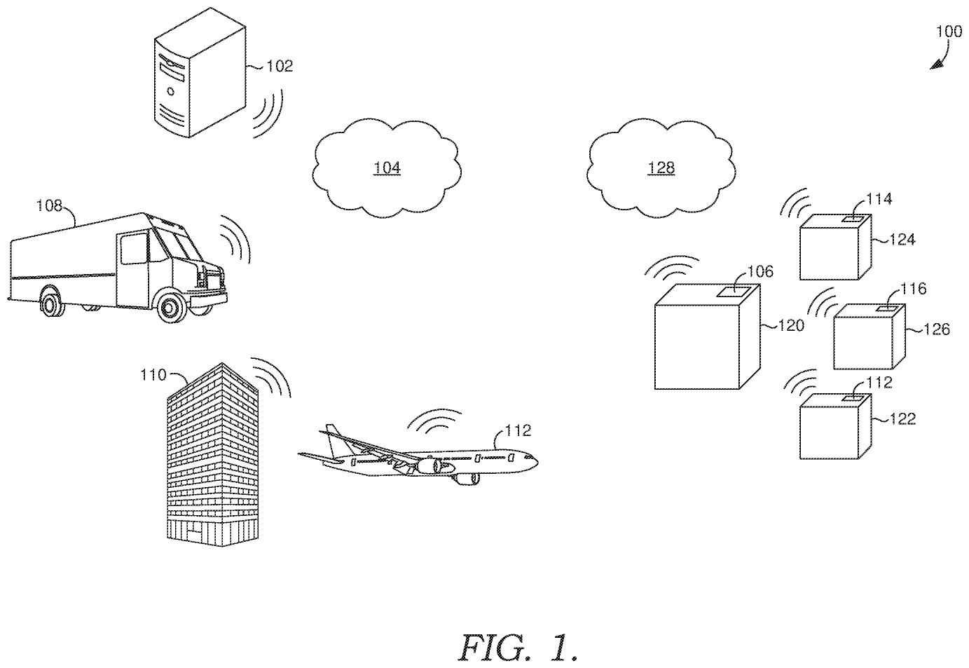

Beginning with FIG. 1, an environment 100 is provided in accordance with embodiments herein. The environment 100 comprises a computing device 102 and a wireless network 104. The computing device 102 may communicate over the wireless network 104 using one or more different technologies or standards, including 3G, 4G, 5G, 6G, LTE, LTE Advanced, CDMA, CDMA 1XA, GPRS, EvDO, TDMA, GSM, WiMax, Bluetooth, Zigbee, or other technology, and/or other frequencies of radio waves, for example. In some embodiments, the wireless network 104 may be a stationary network that is supported using one or more stationary devices located at a defined geographic location. Such stationary devices may comprise, for example, a cell tower, a base station, a MIMO antenna, a pico cell, a femto cell, and/or a repeater. Accordingly, in one embodiment, the wireless network 104 is a telecommunications network. In embodiments, the computing device 102 may communicate with a first device 106 over the wireless network 104. In an embodiment, the computing device 102 may be a server or backhaul device that communicates with other computing or sensor devices (not shown for simplicity) that detect and/or communicate with the first device 106, for example, when the first device 106 is within a communication range of the other computing or sensor devices. The other computing or sensor devices may be located locally or remotely from the computing device 102. Accordingly, the other computing or sensor devices may be distributed at one or more locations throughout a packing, shipping, and delivery supply chain, for example, one or more geographical locations, vehicles, wearable devices, inside or outside buildings (e.g., fulfillment warehouse, loading docks, air cargo compartments, retail stores, carrier-controlled lockers). The other computing or sensor devices, as well as the computing device 102, may wirelessly communicate with the first device 106, directly and/or indirectly. In FIG. 1, the other computing or sensor devices may be co-located with, or integrated into a vehicle 108, a building 110, and/or air cargo plane 112 in the packing, shipping, and/or delivery chain. Further, the other computing or sensor devices may be associated with other networks (e.g., other than wireless network 104) such as a Wi-Fi network accessible through a router or server, for example, within a fixed location, such as a park, a building, a room, a warehouse, and/or a vehicle.

Additionally, a first device 106 and one or more additional devices 114, 116, and 118 are shown in the environment 100. In some embodiments, each of the first device 106 and the one or more additional devices 114, 116, and 118 are physically located or attached to distinct and separate packages that form a group of packages 120, 122, 124, and 126. As such, the first device 106 and one or more additional devices 114, 116, and 118 are mobile devices, in an embodiment. For example, the first device 106 may be physically attached to, integrated with, coupled to, or placed within the interior of one package, e.g., individual package 120. In another example, each of the one or more additional devices 114, 116, and 118 may be physically attached to, integrated with, coupled to, or placed within the interior of separate packages in the group of packages 120, 122, 124, and 126, where the group of packages 120, 122, 124, and 126 corresponds to a multi-package shipment.

The first device 106 may comprise a processor, a wireless transceiver, a memory, and a power supply, in embodiments. The wireless transceiver of the first device 106 is associated with a first wireless communications range, in some embodiments. Additionally, the first device 106 may include one or more sensors for capturing environmental data and/or location data for the package associated with the first device 106. The first device 106 may include, for example, an accelerometer, a gyroscopic sensor, an angular rate sensor (e.g., to detect changes in orientation of a package relative to a designated orientation, “this side up”), a velocity sensor, a thermometer (e.g., to measure the exterior or interior temperature for heat-sensitive items in a package), a humidity sensor, a dampness or water sensor (e.g., to detect when water infiltrates the package or when a liquid item may be compromised), a radiation sensor (e.g., to measure a rate of radioactive decay of an item in the package interior, or to measure radiation exposure for a radiation-sensitive item in a package), a light meter or sensor, a shock or impact sensor (e.g., piezoelectric or piezoresistive), and/or a vibration sensor. The first device 106 may comprise a physical location component for determining a location by leveraging, for example, a Global Positioning System (GPS), Globalnaya Navigazionnaya Sputnikovaya Sistema (GLONASS), BeiDou Navigation Satellite System (BDS), Global Navigation Satellite System (GNSS or “Galileo”), an indoor position system (IPS), or other positioning systems that leverage non-GPS signals or networks (e.g., signals of opportunity (SOP)). Additionally, the first device 106 may be used with different technologies or standards including, for example, 3G, 4G, 5G, 6G, LTE, LTE Advanced, CDMA, CDMA 1XA, GPRS, EvDO, TDMA, GSM, WiMax, Bluetooth, Zigbee, or other technology, and/or other frequencies of radio waves.

The first device 106 may leverage different technologies and standards in order to wirelessly communicate with the computing device 102, whether directly or indirectly, for example, through one or more computing or sensor devices associated with or within the packing, shipping, and delivery supply chain. In various embodiments, the first device 106 may use long-range, medium-range, and/or short-range wireless technologies to communicate with the computing device 102, whether directly or indirectly, for example, through one or more additional computing devices in the packing, shipping, and delivery supply chain. The first device 106 may also communicate wirelessly with the one or more additional devices 114, 116, and 118, in embodiments. In some embodiments, the first device 106 communicates with the one or more additional devices 114, 116, and 118 using short-range technologies, relative to the long-range technologies generally used by the first device 106 to wirelessly communicate with the computing device 102 and/or an external network, such as wireless network 104. The wireless transmitter or wireless transceiver of the first device 106 may be associated with a first wireless communications range that corresponds to medium-range and/or long-range technologies.

In embodiments, each of the one or more additional devices 114, 116, and 118 comprises a processor, a wireless transmitter or a wireless transceiver, a memory, and a power supply. The wireless transmitter or wireless transceiver of the one or more additional devices 114, 116, and 118 may be associated with a second wireless communications range that is less than the first wireless communications range of the first device 106. The second wireless communications range may correspond to short-range technologies, in some embodiments. Examples of short-range or medium-range technologies include Wi-Fi, Near Field Communication (NFC), Bluetooth, and/or Infrared. As used herein, the term “short-range” generally refers to the distance a signal travels in a scale of about 10 meters or less, the term “medium-range” refers to the distance a signal travels in a scale of about 10 up to about 100 meters, and the term “long-range” refers to the distance a signal travels in a scale of about 100 meters and above. These are non-limiting ranges, however, provided herein for discussion purposes only.

The one or more additional devices 114, 116, and 118 communicate with the first device 106 when within the second wireless communications range, while the first device 106 uses a relatively larger and/or stronger signal to communicate with the computing device 102 over the wireless network 104, for example, based on the first wireless communication range. For example, the one or more additional devices 114, 116, and 118 may directly transmit a wireless communication to the first device 106, and the first device 106 may forward the information of the wireless communication to the computing device 102. The one or more additional devices 114, 116, and 118 communicate with one another using short-range technologies, as further discussed herein. In another example, the one or more additional devices 114, 116, and 118 may transmit wireless communications directly to one another. In one example, one of the one or more additional devices 114, 116, and 118 may directly transmit a wireless communication to another device of the one or more additional devices 114, 116, and 118, wherein the receiving additional device may then forward, relay, or push the wireless communication to the first device 106. As such, the one or more additional devices 114, 116, and 118 and the first device 106, together, form a mesh network 128. In embodiments, the mesh network 128 corresponds to a short-range or medium-range communications range, where each device acts as a node. As discussed hereinafter, the mesh network 128 formed by the particular group of devices is used to monitor and track the particular group of packages 120, 122, 124, and 126 of one multi-package shipment.

Each of the first device 106 and the one or more additional devices 114, 116, and 118, described above, are physically attached to, integrated with, coupled to, or placed within the interior of, separate packages that form the group of packages 120, 122, 124, and 126 of the multi-package shipment. Each individual package in the group of packages 120, 122, 124, and 126 may be associated with at least one device, in embodiments. In some embodiments, one of the packages in the group, such as package 120, is associated with the first device 106, and each of the remaining packages in the group, packages 122, 124, and 126, is associated with a separate device from the one or more additional devices 114, 116 and 118. As the one or more additional devices 114, 116, and 118 and the first device 106, together, form the mesh network 128, the mesh network 128 is specific to the group of packages 120, 122, 124, and 126. Further, the mesh network 128 is mobile (i.e., is not associated with a fixed location) because the mesh network 128 inherently travels with the group of packages 120, 122, 124, and 126 by way of the devices acting as nodes to form the mesh network 128. As such, the mesh network 128 provides complete visibility of each individual package in a specific group of packages, by way of the nodes, across any number of different transport modalities and from shipping label creation through final destination, in embodiments.

Generally, the group of packages 120, 122, 124, and 126 may be associated with one shipment manifest and the shipment manifest may specify the quantity of packages to be used to ship items(s) of the shipment manifest. Each package may then be associated with a separate device for monitoring. However, the quantity of packages, the quantity of primary nodes, and the quantity of secondary notes for one multi-package shipment for a shipment manifest may vary and/or be customized. For example, a shipment manifest may indicate that nine items are to be placed into six separate packages for shipping to a user, and one of the packages may be associated with one first device acting as a primary node and the remaining five packages may be each be associated with a separate additional device, acting as secondary nodes in a mesh network. In some embodiments, a group of packages associated with one shipment manifest may be associated with two or more first devices acting as primary nodes and at least one additional device acting as a secondary node. For example, a single shipment manifest may indicate that hundreds or thousands of manufactured items are to be placed into 16,000 separate packages for shipping from a manufacturer through customs to a retailer, and 123 of the packages may be associated with 123 first devices acting as primary nodes and the remainder of the packages may be associated with additional devices acting as secondary nodes in a mesh network.

In embodiments, the group of packages 120, 122, 124, and 126 used to transport items of a shipment manifest are thereby electronically associated with that shipment manifest (i.e., a multi-package shipment) and/or a corresponding shipping record that is associated with the shipment manifest. In the example of FIG. 1, the first device 106 and the one or more additional devices 114, 116, and 118 are associated with one shipment manifest. In some embodiment, a single shipment manifest may be associated with one order or invoice. Alternatively, a single shipment manifest may be associated with more than one order or invoice, wherein the items ordered in the multiple orders or invoices are combined and/or are consolidated together for shipment as one multi-package shipment. Accordingly, a single shipment manifest may indicate or specify that multiple items purchased by a user are to be shipped using multiple, separate package for shipping to the user, such that the grouping of packages may be customized or tailored.

Additionally, the number and size of items, and the number and size of packages, are not limited in dimension, weight, and/or quantity, such that the embodiments herein are scalable. For example, a single shipment manifest may indicate or specify that nine items purchased by a user are to be placed into six separate packages for shipping to the user. In this example, the multi-package shipment comprises six packages. In another example, a single shipment manifest may indicate or specify that hundreds of thousands of manufactured items purchased by a retailer are to be placed into 16,000 separate packages for shipping from the manufacturer through customs to the retailer. In this example, the multi-package shipment comprises 16,000 packages. Accordingly, multiple items (e.g., several different items from a shopping list of miscellaneous sundry, or many of the same item, such as inventory) or several subcomponents of a particular item (e.g., separate parts that may be assembled to form a swing set or to form a portion of a vehicle) may be packaged for shipment by placement into a group of packages, and that group of packages may be associated with the single shipment manifest.

Based on the single shipment manifest, the computing device 102, for example, may generate a shipping record and/or a plurality of shipping labels for the packages to be used for shipment. In embodiments, the computing device 102 may associate the plurality of shipping labels with a plurality of devices that are to be used to monitor the packages. Once shipping labels are electronically generated or scanned into a tracking system, a first device 106 may be electronically linked to one or more of the shipping labels using a unique device identifier of the first device. For example, the first device 106 may be electronically linked to at least a portion of the data that is stored in or encoded by a shipping label, and as such, the first device 106 is electronically linked to at least a portion of the sipping record that corresponds to the shipping label. Each device identifier is unique to and generally corresponds to a different device as discussed herein. In one embodiment, each shipping label comprises a tape identifier that is unique to the shipping label. In embodiments, one device identifier is unique to and corresponds to the first device. Accordingly, the unique device identifier of the first device 106 may be electronically linked or associated with the unique tape identifier of the particular shipping label. In one embodiment, the tape identifier and/or the unique device identifier are used to track the one package that will bear the shipping label in the group of packages 120, 122, 124, and 126, by assuming that the first device 106 is co-located with the one package based on the first device 106 being coupled to, attached to, or integrated into the one package, such as package 120, in the multi-package shipment. For example, in an embodiment, the shipping label may comprise the first device 106, where the first device 106 is an RFID tag integrated into a shipping label itself. In another example, the first device 106 acts as a shipping label, where the first device 106 is an RFID tag that includes shipping information as data. In such examples, the first device 106 and the shipping label are integrated, and/or are one and the same. In this manner, wireless communications that comprise the unique device identifier of the first device 106 and/or detections of the unique tape identifier of the specific shipping label linked to the unique device identifier of the first device 106 are usable by the computing device 102 to monitor and track the one package 120. The process may be repeated for each and every device and shipping label within the multi-package shipment. For example, each package in the multi-package shipment is labeled with a shipping label and includes, as attached or contained within, one device (e.g., first device 106 or the one or more additional devices 114, 116 and 118), wherein a tape identifier of each shipping label is electronically associated or linked to one particular device of a particular package. The associations may be stored through the computing device 102.

A “tape identifier,” as used herein, refers to an identifier that is encoded as a machine-readable code. Examples of a tape identifier include, whether whole, partial, or a combination thereof, a barcode, a unique alphanumeric sequence (e.g., 1Z code), Aztec Code, Code 11, Code 128, Code 39, Extended Code 39, Composite Code, DataMatrix, EAN-13, EAN-8, Industrial 2 of 5, Interleaved 2 of 5, ITF-14, UCC/EAN SCC-14, UCC/EAN-128, LOGMARS, MaxiCode, PDF-417, QR Code, UPC-A, and/or UPC-E. For example, a 1Z code comprises an alphanumeric sequence of “1Z” followed by a six character alphanumeric sequence representing a shipper number, followed by a two numeric character sequence representing a service level indicator, and followed by an eight numeric character sequence, which as a whole, uniquely identifies one particular package.

As mentioned, one of the shipping labels, a corresponding tape identifier, and/or the package associated therewith, is electronically linked to the first device 106, in embodiments. Further, the first device 106 is co-located with one package bearing the linked shipping label and/or corresponding tape identifier. The first device 106 additionally is designated and configured to act as a node in the mesh network 128 that is created for the multi-package shipment, as discussed. The remaining packages in the multi-package shipment are associated with the one or more additional devices 114, 116, and 118, on a one-to-one basis, such that the shipping labels and/or corresponding tape identifiers of the remaining packages are individually associated with specific additional devices. In a similar fashion, the one or more additional devices 114, 116, and 118 are designated and configured to act as nodes of the mesh network 128 that is specific to the particular multi-package shipment. In embodiments, the mesh network 128 is formed using a portion or all of the devices that are electronically linked to the shipping labels for the multi-package shipment and physically co-located with the packages of the multi-package shipment. Generally, each device acts as a node in the mesh network 128, as further discussed in detail.

As the first device 106 and the one or more additional devices 114, 116, and 118 are physically attached to, integrated with, coupled to, or placed within the interior of the packages in the group, the mesh network 128 formed by the first device 106 and the one or more additional devices 114, 116, and 118 is mobile. In embodiments, the mesh network 128 moves with the first device 106 and the one or more additional devices 114, 116, and 118 when the group of packages 120, 122, 124, and 126 are in transit through the packing, shipping, and delivery chain.

In some embodiments, the various devices act as different types of nodes within the mesh network 128. For example, the first device 106 may be configured to act or serve as a “primary” or “parent” node for the mesh network 128 while the one or more additional devices 114, 116, and 118 may be configured to act or serve as “secondary” or “child” nodes in the mesh network 128. The parent and child nodes may be configured differently and may perform different functions in the mesh network 128, in embodiments. Alternatively, all of the nodes in may be configured in the same manner and may perform the same functions in the mesh network 128, in some embodiments.

In one example, the first device 106 that acts as a primary node may be configured to communicate both within the mesh network 128 and outside the mesh network 128 in order to communicate with external networks and/or external devices, such as the wireless network 104, the computing device 102 and/or one or more sensors (e.g., from the one or more additional devices 114, 116, and 118). The first device 106 is generally capable for communication over long-range and/or medium-range technologies, in embodiments. This signal range of the first device 106 is referred to herein as a first wireless communication range. In some embodiments, the first device 106 may be configured to switch between more than one communication mode or protocol, for example, based on the types of available wireless communication networks and resources, and/or based on the amount of power supply remaining for the first device 106.

The one or more additional devices 114, 116, and 118 are configured to provide information to one another and the first device 106 using the mesh network 128, in some embodiments. The one or more additional devices 114, 116, and 118 may act or serve as secondary nodes that use short-range technologies to communicate between themselves (secondary nodes), and/or to the first device 106 acting as the primary node. The signal range of the one or more additional devices 114, 116, and 118 is referred to herein as a second wireless communications range.

In some embodiments, the first device 106 exhibits a greater communications range than the one or more additional devices 114, 116, and 118, and therefore, the first device 106 is designated to act as the primary node for the mesh network 128. For example, the first device 106 may be capable of interfacing with the wireless network 104. In contrast, for example, the one or more additional devices 114, 116, and 118 may lack a long-range communications range and may be not capable of interfacing with the wireless network 104. In this example, the second wireless communications range is less than the first wireless communication range.

Regarding the mesh network 128 formed by the devices associated with the multi-package shipment, the number of primary nodes relative to secondary nodes may vary. Generally, mobile mesh networks of the embodiments herein have a greater quantity of secondary nodes than primary nodes. In one example, when the multi-package shipment comprises six separate packages, one of the packages may be associated with one device that acts as the sole primary node in the mesh network and the five remaining packages are associated with additional devices that act as secondary nodes in the mesh network. In another example, when the multi-package shipment comprises 16,000 separate packages, 100 of the packages may be associated with 100 devices that act as primary nodes in the mesh network and the remainder of the packages that are associated with the additional devices act as secondary nodes in the mesh network.

Returning to FIG. 1, the group of packages 120, 122, 124, and 126 may be monitored by leveraging the mesh network 128 formed by the first device 106 and one or more additional devices 114, 116, and 118 as the group of packages 120, 122, 124, and 126 travel through various points in the packing, shipping, and delivery chain. The mesh network 128 is used to provide “high resolution” or “fine grain” visibility for each package in the group of packages 120, 122, 124, and 126 through at least a portion of packing, shipping, and delivery chain. In particular, configuring the first device 106 to serve as the primary node enables the first device 106 to act or serve as a proxy data source for the one or more additional devices 114, 116, and 118, for the purposes of monitoring the group of packages 120, 122, 124, and 126. For example, because the group of packages 120, 122, 124, and 126 may generally travel together through the same or similar conditions from initial retrieval and packing to delivery, the environmental conditions and/or location information obtained through the first device 106 of one package is representative, by proxy, of the environmental conditions and/or location information for the one or more additional devices 114, 116, and 118 and corresponding packages in the group. As such, the first device 106 gathers information from the one or more additional devices 114, 116, and 118 over the mesh network 128, and the computing device 102 monitors the first device 106 and uses the first device 106 to track one or more, or all, of the packages in the group of packages 120, 122, 124, and 126. The benefits and technological improvements over other technologies, as provided by embodiments herein, will become apparent to those having skill in the art in view of this Detailed Description, and as discussed herein.

It is noted that although the shipment manifest is discussed in the singular form, it will be understood that more than the single shipment manifest may be formed by aggregating or consolidating multiple shipment manifests together at one or more points during the packing, shipment, and delivery chain, for example. As such, more than one mesh network may be consolidated and/or combined together at one or more points during the packing, shipment, and delivery chain, for example, to form one mesh network that reflects the aggregation or consolidation of multiple packages into one shipment manifest.

It is noted that although the mesh network 128 is discussed with regard to enabling communication between the first device 106 and/or the one or more additional devices 114, 116, and 118, the mesh network 128 may be configured to communicate with external networks other than the wireless network 104 of FIG. 1. An external network may be another mobile mesh network, in one embodiment, formed by a different group of packages for a different shipment, but which is in range of the first device. An external network may be another mobile mesh network, in one embodiment, formed by a different group of packages for a different shipment, but which is in range of the first device.

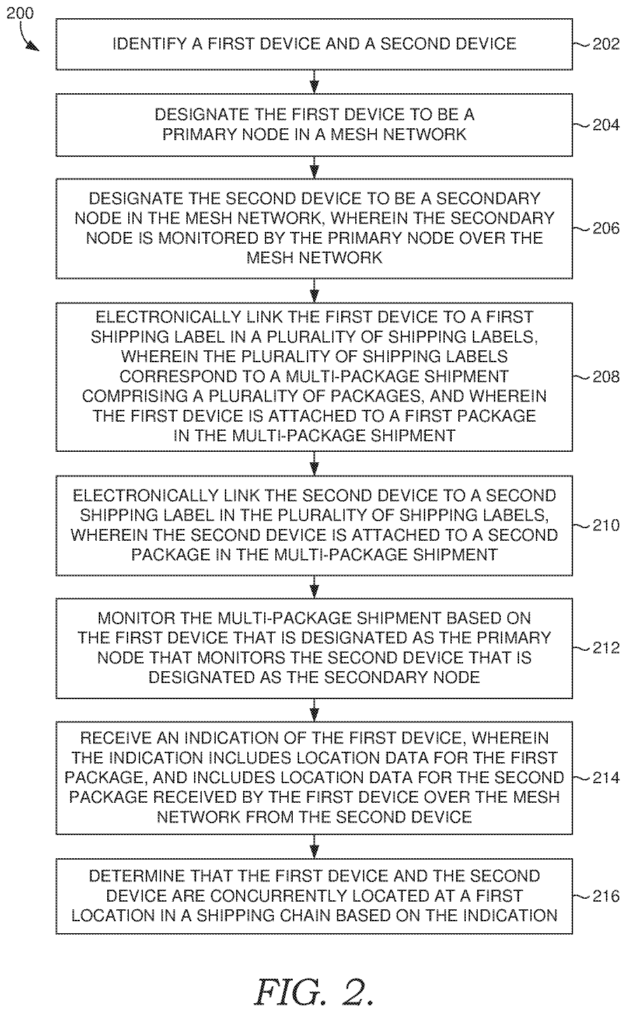

Turning now to FIG. 2, a method 200 is presented in accordance with embodiments herein. The method 200 may be a computer-implemented method, in some embodiments. In one embodiment, one or more non-transitory computer-readable storage media having computer-readable program code portions embodied thereon are used to implement the method 200. For example, the computer-readable program code portions may include one or more executable portions configured to perform the method 200, in an embodiment. The computer-readable storage media and/or computer-readable program code portions may correspond to an application that performs the method 200, in one embodiment. As discussed below, the method 200 may be performed using one or more of the components shown in FIG. 1, for example. Accordingly, the method 200 may be performed by a computing device, e.g., the computing device 102. Such a computing device may be highly complex and specially configured to support a tracking system by interfacing with, and managing data received, directly or indirectly, through tens to millions of data-capturing devices (e.g., cameras, video cameras, infrared sensors, optical scanners, NFC sensors, mobile devices, stationary devices) distributed and located among tens to thousands of different locations and/or buildings, in order to form a vast network on a country-wide to global-scale, as opposed to a generic computing device. Accordingly, the computing device may be used to perform steps of the method 200, for example, that cannot be performed mentally or with pen-and-paper.

Beginning at block 202, a first device and a second device are identified, in embodiments. In some embodiments, a computing device identifies the first and second device by wirelessly receiving a unique device identifier for each of the first and second device, for example, as sent from the first and second devices, as provided from another device, such as a server, and/or as determined by a scanning device. A first unique device identifier may be received, directly or indirectly, by a computing device communicating over a wireless network, for example. Additionally, in an example, a second unique device identifier may be received, directly or indirectly, by a computing device communicating over a wireless network. The unique device identifiers may be stored in memory, in some embodiments, so that that the unique device identifiers may be referenced subsequently in order to recognize communications that are sent from, or which originate from, one or more of the first and second devices. In some embodiments, the unique device identifiers may be electronically linked to a particular shipping record and/or a specific shipment manifest.

The method 200 facilitates the creation of a mesh network that is formed by the first and second devices, such that the mesh network is specific to the particular shipping record and/or corresponding shipment manifest, in embodiments. At block 204, the first device is designated as a primary node in the mesh network, in an embodiment. Generally, the first device may be configured similarly as the first device discussed with regard to FIG. 1. In some embodiments, the first device automatically configures itself to act as a primary node using computer instructions stored on the first device, for example, without receiving or requiring input, instructions, and/or authorization from an external device, such as the computing device or a server. In further embodiments, the computing device may send or “push” computer-readable instructions to the first device, wherein automatic execution of the computer-readable instructions by a processor of the first device configures the first device to act as a primary node in forming the mesh network. In some embodiments, the first device automatically configures itself to act as a primary node in response to a specified event such as the first device powering on, the first device detecting a proximate device such as a scanning device, the first device being interrogated by a scanning device, for example, without receiving or requiring authorization from an external device, such as the computing device or a server.

Generally, a primary node is configured to monitor, continuously or periodically, one or more secondary nodes over the mesh network. In this manner, the first device is designated as the primary node and the first node becomes active in the mesh network. The first device, which acts as the primary node, may communicate over the mesh network using short-range technologies, and in some embodiments, communicate over other networks using one or more of medium-range or long-range technologies.

At block 206, the method 200 designates the second device to be a secondary node in the mesh network, in embodiments. Generally, the second device may be configured similarly as the additional devices discussed with regard to FIG. 1. In some embodiments, the second device is preconfigured and/or automatically configures itself to act as a secondary node using computer instructions stored on the second device, for example, without receiving or requiring input, instructions, and/or authorization from an external device, such as the computing device or a server. The computing device may send or “push” computer-readable instructions to the second device, wherein automatic execution of the computer-readable instructions by a processor of the second device configures the second device to act as a secondary node in the mesh network that is being created, in embodiments. In some embodiments, the second device automatically configures itself to act as a secondary node in response to a specified event such as the second device powering on, the second device detecting a proximate device such as a primary node and/or a scanning device, the second device being interrogated by a primary node and/or a scanning device, for example, without receiving or requiring authorization from an external device, such as the computing device or a server. In this manner, the second device is designated as the secondary node and the secondary node becomes active in the mesh network. Generally, a secondary node is configured to be monitored by the primary node over the mesh network, in embodiments. The second device, which acts as a secondary node, communicates over the mesh network using short-range technologies, as previously described.

In some embodiments, the first device is designated to act as a primary node based on identifying the first device and/or the unique device identifier of the first device, and/or the second device is designated to act as a secondary node based on identifying the second device and/or the unique device identifier of the second device. The information regarding each device may be determined based on information obtained during identification of the devices and/or may be related or encode using the unique device identifiers. In one example, when the first device and the second device are identified, the computing device may recognize that the first device is a device (e.g., identifying or recognizing a specific make, model, components, functions, and/or capabilities) that has medium-range and/or long-range communication capabilities. In the example, the computing device may recognize that the second device is a device (e.g., identifying or recognizing a specific make, model, components, functions, and/or capabilities) that does not have medium-range and/or long-range communication capabilities and that does have short-range communication capabilities. Based on specifications of the second device and/or the capabilities of the first device, the computing device may designate the second device to serve as a secondary node and may designate the first device to serve as the primary node.

In another example, the first device may have telecommunications capabilities and the second device may lack these abilities, based on hardware such as equipment and components (e.g., transmitter, receiver, processor and processor speed, memory and amount of memory, power supply and capacity in that power supply), and/or other specifications, such as available software drivers or protocol compatibility/incompatibility. As such, in some embodiments, the computing device may select the first device to be designated as the primary node based on the long-range communication capacity to communicate beyond the mesh network being created. In the example, the computing device may select the second device to be designated as the secondary node because the second device may handle short-range communications in the mesh network but may not be capable of, or may not be reliably capable of, handling long-range communications. Alternatively, in some embodiments, the first device may designate itself to operate as the primary node in a mesh network based on the first device's capability for long-range communications whereas the second device may designate itself to operate as a secondary node in the mesh network based on the second device's inability or limitations for using short-range communications and lack of long-range communication software, hardware, or components. In such embodiments, the first and second device may be preconfigured and/or may configure themselves to operate at specific nodes without receiving, requiring, or requesting permission, authorization, or instructions from an external device such as a computing device or server, for examplex.

When the first and second devices have been powered on, have been designated as nodes, and any applicable configuration has occurred, the mesh network is created and is active. Once created, the first and second devices can communicate directly with one another over the mesh network, in embodiments.

It will be understood that the second device may be designated as the second node concurrently in time with the first device being designated as the primary node, and the order shown in FIG. 2 is not meant to be limiting. For example, the computing device may concurrently send or push separate computer-readable instructions to each of the first device and second device, wherein automatic execution of the computer-readable instructions by a processor at each of the first and second devices configures the respective first and second devices to act as a primary node or a secondary node in the mesh network that is being created. In another embodiment, the computing device may send or push separate computer-readable instructions for both the first and second devices to only the first device, wherein automatic execution of the computer-readable instructions by a processor at the first device configures the first device to act as a primary node in the mesh network that is being created, and further, causes the first device to forward or relay the separate computer-readable instructions for the second device to the second device for configuration in the mesh network.

Turning to block 208, the method 200 electronically links the first device to a first shipping label in a plurality of shipping labels, where the plurality of shipping labels correspond to a multi-package shipment comprising a plurality of packages, in embodiments. For example, when a plurality of shipping labels are generated for the shipment manifest, the first device that acts as a primary node in the mesh network may be electronically linked to one or more of the shipping labels using the unique device identifier of the first device. In one embodiment, the unique device identifier of the first device may be associated with a unique tape ID of the shipping label. Additionally, the first device may be coupled to, attached to, or integrated into a first package in the multi-package shipment, in various embodiments. Accordingly, the first device is presumed to travel along with the first package during transport. In this manner, communications that comprise the unique device identifier of the first device and/or detections of the unique tape ID of the specific shipping label linked to the unique device identifier are usable by the computing device to monitor and track the first package.

At block 210, the method 200 electronically links the second device to a second shipping label in the plurality of shipping labels, in embodiments. The second device may be coupled to, attached to, or integrated into a second package in the multi-package shipment, in embodiments. Accordingly, the first device is presumed to travel along with the first package during transport. In this manner, communications that comprise the unique device identifier of the second device and/or detections of the unique tape ID of the specific shipping label linked to the unique device identifier are usable by the computing device to monitor and track the second package. Accordingly, when the mesh network that is specific to one particular group of packages is active (i.e., based on the first and second devices have been powered on, designated as nodes, and any applicable configuration having occurred), each of the individual packages corresponding to the electronically linked shipping labels may thus be tracked, for example, using the first device as a primary node. The process of designating additional devices as nodes in the mesh network and electronically linking the additional devices to shipping labels of additional packages may be performed, for example, for a portion or all of the packages in the one particular group. In embodiments, the designation of devices as nodes and the electronic linking of specific devices to particular packages in a group may be performed locally with respect to the packages using one or more external devices, e.g., an RFID reading device, an optical scanning device, a mobile or fixed-location computing device. For example, the designating, linking, and adding of nodes to a mesh network are aspects of the method 200 that can be performed without input from a server and/or can be performed without receiving or requiring permission or authorization from a server. Additionally, creating mesh networks, node designations, and linking can be performed for a plurality of groups of packages throughout a global carrier environment, such that each group of packages can have a corresponding mesh network that is specific to that particular group of packages.

At block 212, the multi-package shipment is monitored based on the first device that is designated as the primary node, where the first device acts as a primary node that monitors the second device that is designated as the secondary node, in some embodiments. The first device, therefore, acts as a proxy for the second device such that the first and second package are both monitored by monitoring the first device. Unlike other technologies that may attempt to track packages on a one-to-one basis, and which consumes a vast amount of hardware and software resources to handle the exponentially growing amount of data, the method 200 herein may track the first device and proxy to one or more other devices, such as the second device.

In some embodiments, the multi-package shipment is monitored based on the detection of a unique tape identifier that is associated with a particular shipping label, and where the particular shipping label and/or the unique tape identifier is electronically linked to one device attached to a package in the multi-package shipment. For example, a portion or all of the packages in the multi-package shipment may be monitored based on the detection of a unique tape identifier that is associated with a particular shipping label, and where the particular shipping label and/or the unique tape identifier is electronically linked to the first device that is the primary node in the mesh network. In one such embodiment, the other devices in the multi-package shipment may be detected by the first device over the mesh network, for example, by sending a unique tape identifier to the first device. The first device may aggregate a portion or all of the unique tape identifiers of the other devices in the multi-package shipment, including the unique tape identifier associated with the first device, and then may transmit a portion or all of the unique tape identifiers for detection and monitoring purposes.

As such, the method 200 creates multiple mobile mesh networks that track packages at a ratio that is greater than 1:1 (e.g., two or more packages, or all of the packages in a multi-package shipment are tracked through the one device acting as the primary node in the mesh network), and this is an improvement over other technologies that optimizes (e.g., reduces) hardware and software resource consumption throughout the entire tracking system. Because the method is highly scalable, as explained in earlier examples (e.g., 16,000 packages belonging to one shipment manifest and associated with a mesh network having one device acting as the primary node), optimizing hardware and software resource consumption is a non-negligible technological benefit when implemented in the tracking system. Additionally, optimizing hardware and software resource consumption is a non-negligible technological benefit when implemented in the tracking system that, as discussed above, interfaces with and manages data received, directly or indirectly, through tens to millions of data-capturing devices distributed and located among tens to thousands of different locations and/or buildings, in order to form a vast network on a country-wide to global scale.

In monitoring the multi-package shipment comprising the first and second packages, the first device acts as a proxy for the first package and the second package. For example communications involving the unique identifier of the second device may be sent, using the mesh network, from the second device to the first device that is the primary node, and then the first device may further send that communication and/or additional information to the computing device, directly or indirectly, using a wireless network or other external network, for example. In one embodiment, communications involving the unique identifier of the first device may be sent, using the mesh network, from the first device to the computing device, directly or indirectly, using a wireless network or other external network. In some embodiments, the first device, acting as the primary node, communicates with external networks or devices, whereas the second device, acting as the secondary node, communicates only through the mesh network. Because the second device is presumed to travel with the second package and the first device is presumed to travel with the first package, when the first device detects the second device over the mesh network that uses short-range communications, for example, the first device may “report” on the presence of both the first and second packages.

Continuing with the method 200, an indication of the first device is received at block 214, where the indication includes location data for the first package, and includes location data for the second package received by the first device over the mesh network from the second device. It will be understood that the location data may correspond to and/or be determined using data compatible with Global Positioning System (GPS) satellites, such as Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using any or a combination of coordinate systems, such as the Decimal Degrees (DD); Degrees, Minutes, Seconds (DMS); Universal Transverse Mercator (UTM); Universal Polar Stereographic (UPS) coordinate systems; and/or triangulation techniques may be used in connection with a device and various communication points (e.g., cellular towers or Wi-Fi access points) positioned at various locations throughout a geographic area. The received indication may also include, in some embodiments, a unique sensor identifier for a sensor associated with the first device and a unique 1Z code that is specific to the shipment and/or the shipping label that is electronically linked to the first device for a particular package. Additionally, in some embodiments, the indication may include a unique sensor identifier for a sensor associated with the second device and a unique 1Z code that is specific to the shipment and/or the shipping label that is electronically linked to the second device for a particular package. In yet another embodiment, the received indication may include a unique sensor identifier for a sensor associated with the first device, a unique 1Z code that is specific to the shipping label that is electronically linked to the first device for a particular package, and a unique 1Z code that is specific to the shipping label that is electronically linked to the second device for a particular package. In various embodiments, the indication received from the first device may include location information, one or more 1Z codes, and/or one or more sensor identifiers for each of a plurality of secondary nodes in the mesh network.

The indication of the first device may be received directly from the first device over a wireless network, or may be received via one or more sensors that detect at least one of the mesh network or the first device, where the one or more sensors are located at a warehouse, facility, building, in an air cargo plane, a tractor trailer, a loading or unloading zone, in a delivery vehicle, or located anywhere in the packing, shipping, and delivery chain. Because the first device may have long-range communication capabilities, the indication of the first device may be sent intermittently, periodically at fixed or defined time intervals, or continuously throughout transport of the multi-package shipment, for example, to the computing device using an external network or telecommunication network. In some embodiments, the indication of the first device may be sent when or as triggered by one or more points in the packing, shipping, and delivery chain, for example, when the first device is detected at a consolidation facility, at a hub, or as loaded to or unloaded from a delivery vehicle, and/or when an airplane arrives at or leaves an airport and the first package is recorded as being in transport by that airplane. As such, the term “periodically” encompasses occurrences based on a regular and repeating time interval, a defined schedule, triggered events, or a combination thereof.

For example, the first device may leverage long-range communications and send a report on the multi-package shipment over a telecommunications network to the computing device. In another example, the first device may leverage a short-range or medium-range network such as Wi-Fi when a telecommunications network is unavailable to the first device, such that the first device sends a report on the multi-package shipment to the Wi-Fi network, and the Wi-Fi network is able to communication to the computing device. Each of these communications may comprise, for example, the first and second unique device identifiers when indicating that the first device detects the second device via the mesh network, for example. Alternatively, one or more of these communications may comprise, for example, the first unique device identifier but not the second unique device identifier when indicating that the first device does not, at that time, detect the second device via the mesh network. Based on the first device's ability to communicate at any time within the packing, shipping, and delivery chain, and over more than one external network, the mesh network creates “high resolution” or “fine grain” visibility for the specific multi-package shipment throughout the entirety of the packing, shipping, and delivery chain. In other words, a portion or all of the packages may be accounted for by monitoring the first device, as the first device uses the mesh network to individually monitor the first package itself and monitor the second package through the second device.

In some embodiments, the indication of the first device indicates that the first device designated as the primary node has detected the second device over the mesh network at a particular time and date (e.g., timestamp). Further, the indication may indicate that the location data for the first package and the location data for the second package concurrently correspond to the first location at that particular time or time period. In another embodiment, the indication may indicate that the location data for the first package corresponds to the first location at a particular time and that the first device detects the second package over the mesh network at that particular time.

Based on the indication, at block 216, the method 200 determines that the first device and the second device are concurrently located at a first location in a packing, shipping, and delivery chain based on the indication. In this manner, the computing device, for example, may recognize that a portion or all of the packages of the multi-package shipment are co-located at the first location and that, by proxy, none of the packages of the multi-package shipment are lost, misplaced, or delayed. In various embodiments, based on the indication received from the first device, which may include location information, one or more 1Z codes, and/or one or more sensor identifiers for each of a plurality of secondary nodes in the mesh network, it may be determined whether one or more of the packages for which the corresponding shipping labels are electronically linked to secondary nodes in the mesh network are or are not concurrently located relative to the other packages in the group. For example, it may be determined by the computing device that packages no. 4 and no. 8 associated with a group of 15 packages are not concurrently located with packages nos. 1-3, 5-7, and 9-15 when location and timestamp information for package nos. 4 and 8 is not encoded in the indication received while location and a timestamp information for each of packages nos. 1-3, 5-7, and 9-15 is encoded in the indication.

It will be understood that the first location may be anywhere in the packing, shipping, and delivery chain or along travel routes, for example, such that the first location is not to be construed as limited to a warehouse, facility, building, delivery vehicle, air cargo plane, mile marker, or the like. The first location may be determined using any of, or a combination of, the location systems previously mentioned herein and/or based on communications with other external devices that may report a geographic or physical location to the primary node of the mesh network, for example. In further embodiments, based on determining that the first device and the second device are concurrently located at the first location, authorizing movement of the first package and the second package to a second location in the shipping chain. In one embodiment, based on determining that the first device and the second device are concurrently located at the first location in the shipping chain, communicating a notification that confirms the first package and the second package were concurrently received at the first location in the shipping chain. In yet another embodiment, based on determining that the first device and the second device are concurrently located at the first location in the shipping chain, communicating a notification that provides clearance for the first package and the second package to be moved to a second location in the shipping chain. After device node designation and linking of devices to packages in a group, the detection of one or more secondary nodes by one or more primary nodes within a mesh network may be repeated continuously or periodically to monitor transport of the group of packages and detect the presence, loss, misplacement, and/or misrouting of each individual package in the group, from the creation and activation of the mesh network through to the shipment's final destination location (i.e., delivery end-point).

The methods discussed herein may be used in specific and practical applications, for example, to monitor and track the transport and transport conditions of items. For example, one or more healthcare items may be sensitive to environmental changes (e.g., specific temperature thresholds may inactive enzymes or render biological samples useless, UV rays or other radiation may degrade compositions or destroy films, violent transport or handling may damage medical equipment having sensitive components and/or calibrations). In such embodiments, the sensors of one or more of the devices that are acting as nodes within the mesh network can communicate data points of the measurements collected and captured by the sensors during transport to the primary node, for some portions or the entirely of transport, such that the environmental conditions and changes experienced by the group of packages is recorded from shipping label creation to final destination. This information may be utilized to guarantee delivery and integrity of the healthcare items, for example. Accordingly, it may be determined by a computing device that a group of packages was exposed to a temperature of 90 degrees Fahrenheit at one or more particular geographic locations for a defined duration of 1 hour and 3 minutes, based on an indication received that includes a device identifier, a sensor identifier, location, timestamp, and sensor-collected data from, at least, one or more sensors of the primary node of the mesh network for the group of packages. In another example, it may be determined by a computing device that a group of packages was maintained at a humidity in the range of 40 to 60% for the entirety of package monitoring during transport, based on an indication received that includes a device identifier, a sensor identifier, location, timestamp, and sensor-collected data from, at least, one or more sensors of the primary node of the mesh network for the group of packages.

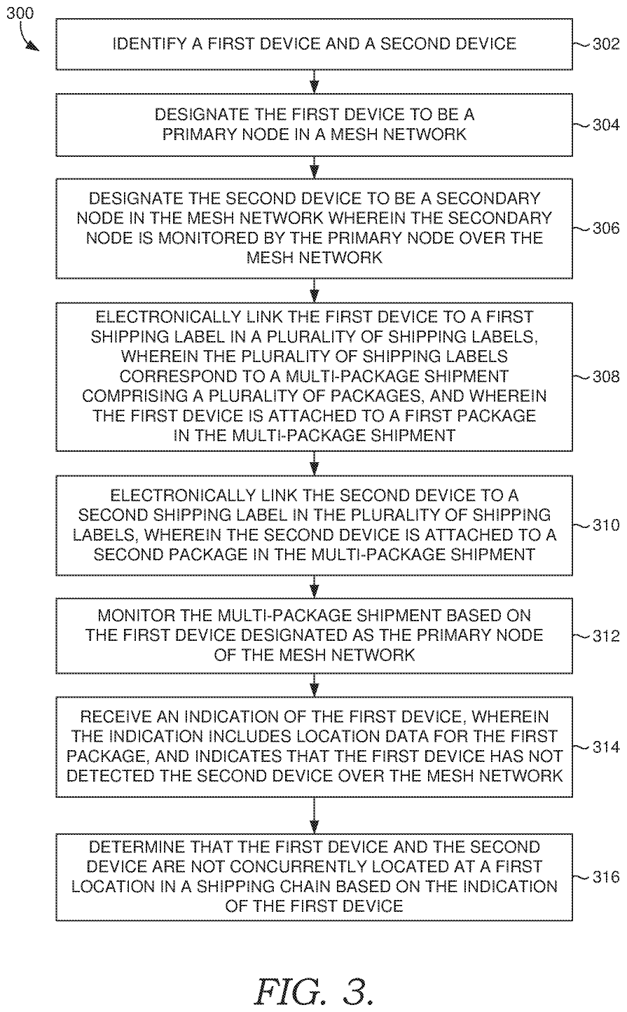

Continuing on to FIG. 3, a method 300 is presented in accordance with embodiments herein. The method 300 may be a computer-implemented method, in some embodiments. In one embodiment, one or more non-transitory computer-readable storage medium having computer-readable program code portions embodied therein are used to implement the method 300. For example, the computer-readable program code portions may include one or more executable portions configured to perform the method 300, in an embodiment. The computer-readable storage media and/or computer-readable program code portions may correspond to an application that performs the method 300, in one embodiment. As further discussed below, the method 300 may be performed using one or more of the components shown in FIG. 1, for example. Accordingly, the method 300 may be performed by a computing device, e.g., the computing device 102. Such a computing device may be highly complex and specially configured to support a tracking system by interfacing with, and managing data received, directly or indirectly, through tens to millions of data-capturing devices (e.g., cameras, video cameras, infrared sensors, optical scanners, NFC sensors, mobile devices, stationary devices) distributed and located among tens to thousands of different locations and/or buildings, in order to form a vast network on a country-wide to global scale, as opposed to a generic computing device. Accordingly, the computing device may be used to perform steps of the method 300, for example, that cannot be performed mentally or with pen-and-paper. Additionally, one or more steps of the method 300 may be performed in the same or similar manner as those same or similar steps discussed previously, with regard to the method 200. For brevity, the same or similar steps of the method 300 will be not be discussed in detail.

Beginning with block 302, a first device and a second device are identified. At block 304, the first device is designated to be a primary node in a mesh network, in some embodiments. And at block 306, the second device is designated to be a secondary node in the mesh network, where the secondary node is monitored by the primary node over the mesh network, as discussed above. In accordance with the method 300 at block 308, the first device is electronically linked to a first shipping label in a plurality of shipping labels. In embodiments, the plurality of shipping labels correspond to a multi-package shipment comprising a plurality of packages, and the first device is attached to a first package in the multi-package shipment, in an embodiment. At block 310, the second device is electronically linked to a second shipping label in the plurality of shipping labels, where the second device is attached to a second package in the multi-package shipment, in some embodiments. Continuing, the multi-package shipment is then monitored, at block 312, based on the first device designated as the primary node of the mesh network. In some embodiments monitoring the multi-package shipment based on the first device designated as the primary node of the mesh network comprises receiving one or more notifications sent from the first device as the first package travels through the shipping chain. For example, the one or more notifications may include location data for the first package captured by the first device and/or location data for the second package sent by the second device to the first device over the mesh network.

At block 314, an indication of the first device is received, where the indication includes location data for the first package, and indicates that the first device has not detected the second device over the mesh network, in embodiments of the method 300. The indication of the first device may be received directly from the first device over an external network, or via one or more sensors located at the first location that detect the mesh network and/or the first device.

The indication may provide data or information indicating when the first device was able to, or was unable to, detect and identify one or more particular devices (e.g., unique device identifiers) in the mesh network. For example, the indication may encode data specifying that the first device was unable to directly detect the second device based on a lack of receipt of a periodically transmitted signal, with a unique device identifier, from the second device over the mesh network, in one embodiment. The indication may encode data specifying that the first device was unable to indirectly detect the second device, in one embodiment, based on receipt of a periodically transmitted signal from a third device over the mesh network, wherein the periodically transmitted signal from the third device did not include a unique identifier for the second device, thereby indicating that a signal from the second device was unable to be detected by the third device in the mesh network.

At block 316, the first device and the second device are determined to not be concurrently located at a first location in a shipping chain based on the indication of the first device. As the indication indicates that the first device does not or has not detected the second device over the mesh network at that time, and has also indicated that the first device is at the location, it may be determined that the second device is not co-located with the first device, and further, that the second package is not located at the first location with the first package.

Based on the determination that the first and second devices are not concurrently located at the first location, the method 300 instantiates and/or performs one or more actions to locate the second package. For example, based on determining that the first device and the second device are not concurrently located at the first location, the method 300 may communicate computer instructions to an external device to locate the second package by initiating detection of the second device. For example, computer instructions may be communicated to an external device having one or more sensors that may be activated and used to attempt to detect and thus locate the second package. The external device may be located at the first location, in some embodiments. Alternatively, the external device may be located at another location. For example, the computing device may determine, from prior monitoring, a last known location of the second device where the second device was detected, by the first device and/or one or more sensors. In one such example, computer instructions may be communicated to an external device at the last known location of the second device in order to attempt to detect and thus locate the second package.

In some embodiments, based on determining that the first device and the second device are not concurrently located at the first location, the method 300 may communicate a notification that indicates the second package was not concurrently received at the first location with the first package. The notification may be communicated to a consignee for the multi-package shipment, to a Global Customs Clearance computing entity, and/or to a carrier entity, for example. In an embodiment, based on determining that the first device and the second device are not concurrently located at the first location, the method 300 may communicate a notification that indicates the second package is delayed. The notification may be communicated to a consignee computing entity for the multi-package shipment, to a Global Customs Clearance computing entity, and/or to a carrier computing device, for example.

In an embodiment, based on determining that the first device and the second device are not concurrently located at the first location, the method 300 may communicate an instruction to hold the first package at the first location for a defined period of time. The instruction may be communicated to a consignee computing entity for the multi-package shipment, to a Global Customs Clearance computing entity, and/or to a carrier computing device, for example.

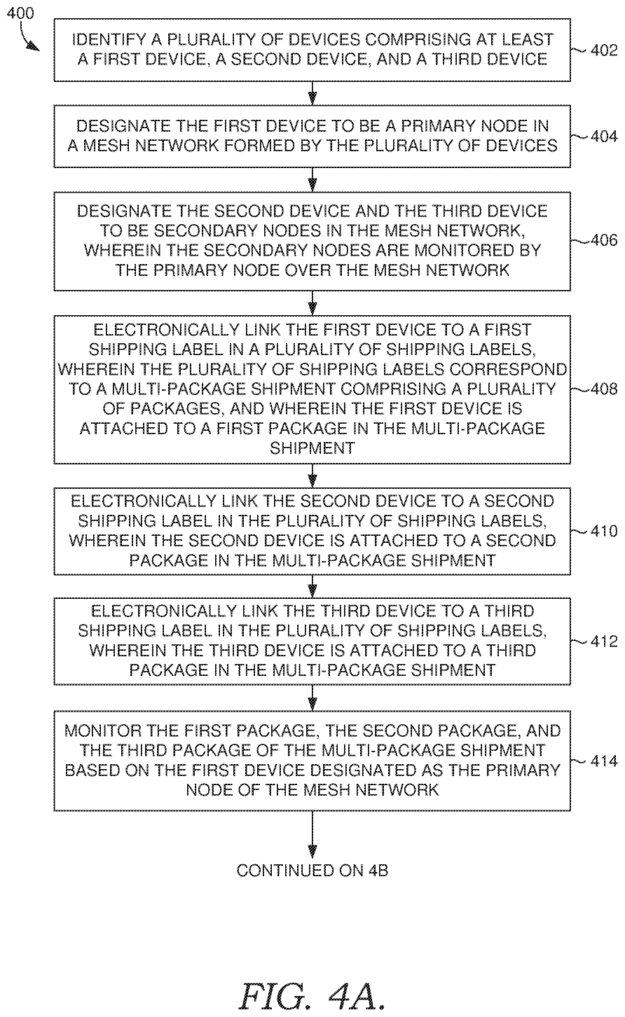

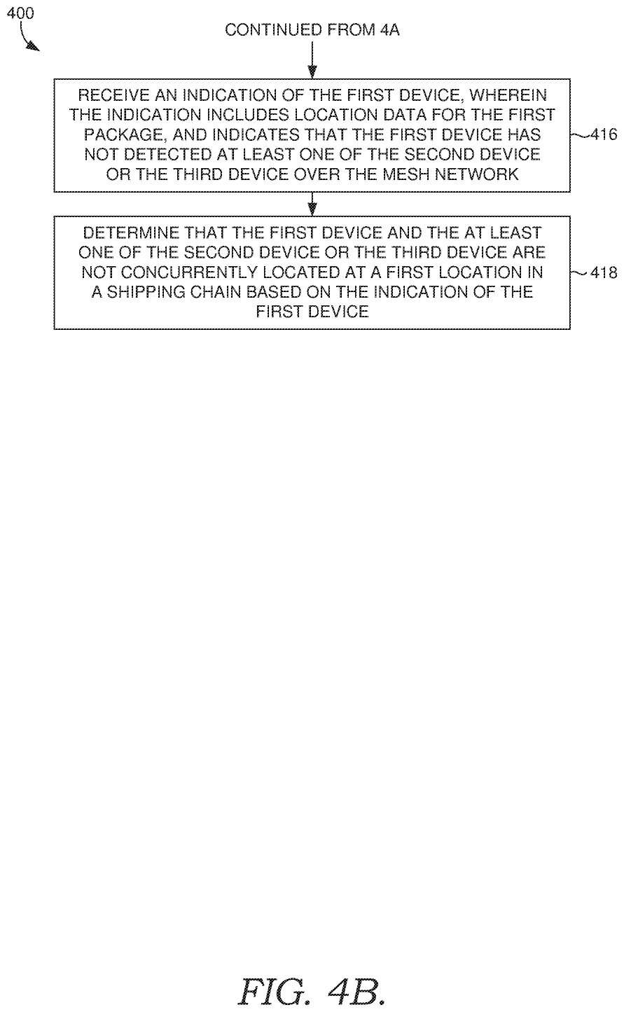

FIG. 4 depicts another method 400, in accordance with an embodiment. The method 400 may be a computer-implemented method. In one embodiment, one or more non-transitory computer-readable storage medium having computer-readable program code portions embodied therein are used to implement the method 400. For example, the computer-readable program code portions may include one or more executable portions configured to perform the method 400, in an embodiment. The computer-readable storage media and/or computer-readable program code portions may correspond to an application that performs the method 400, in one embodiment. As further discussed below, the method 400 may be performed using one or more of the components shown in FIG. 1, for example. Accordingly, the method 400 may be performed by a computing device, e.g., the computing device 102. Such a computing device may be highly complex and specially configured to support a tracking system by interfacing with, and managing data received, directly or indirectly, through tens to millions of data-capturing devices (e.g., cameras, video cameras, infrared sensors, optical scanners, NFC sensors, mobile devices, stationary devices) distributed and located among tens to thousands of different locations and/or buildings, in order to form a vast network on a country-wide to global scale, as opposed to a generic computing device. Accordingly, the computing device may be used to perform steps of the method 400, for example, that cannot be performed mentally or with pen-and-paper. Additionally, one or more steps of the method 400 may be performed in the same or similar manner as those same or similar steps discussed previously, with regard to the method 200 and the method 300. For brevity, the same or similar steps of the method 400 are not discussed in detail.

At block 402, a plurality of devices comprising at least a first device, a second device, and a third device are identified. Then, at block 404, the first device is designated to be a primary node in a mesh network formed by the plurality of devices. In some embodiments, rules are communicated to the first device designated as the primary node, wherein the rules configure the first device to operate as the primary node in the mesh network. At block 406, the second device and the third device are designated as secondary nodes in the mesh network, wherein the secondary nodes are monitored by the primary node over the mesh network. In some embodiments, rules are communicated to the second and third devices designated as the secondary nodes, wherein those rules configure the second and third devices to operate as secondary nodes in the mesh network. In some embodiments, a notification is received by, for example, the computing device, that indicates the mesh network formed by the first device, the second device, and the third device is active.

At block 408, the first device is electronically linked to a first shipping label in a plurality of shipping labels, wherein the plurality of shipping labels correspond to a multi-package shipment comprising a plurality of packages, and wherein the first device is attached to a first package in the multi-package shipment. At block 410, the second device is electronically linked to a second shipping label in the plurality of shipping labels, wherein the second device is attached to a second package in the multi-package shipment. And at block 412, the third device is electronically linked to a third shipping label in the plurality of shipping labels, wherein the third device is attached to a third package in the multi-package shipment. As such, each device is electronically linked and attached to a different package within the multi-package shipment.

At block 414, the method 400 monitors the first package, the second package, and the third package of the multi-package shipment based on the first device designated as the primary node of the mesh network. The second and third devices send, over the mesh network, indications of their connection to the network for receipt by the first device acting as the primary node. The first device uses these communications to determine whether or not the second and third devices are physically co-located with the first device, as a proxy for determining whether the first, second, and third devices are traveling together. If the first device loses a signal from the second device over the mesh network, for example, the first device may determine that the second package is no longer co-located with the first package, which may indicate that the second package has been misplaced, delayed, or lost during transport.

It is noted that the primary node may receive a signal directly from one or more of the secondary nodes that confirms a connection to the mesh network. Further, because the network is a “mesh” network, the secondary nodes may detect each other's signal and forward the information to the primary node, such that one secondary node may report to the primary node that another secondary node is connected to the mesh network, even when the primary node may not directly detect that signal. Accordingly, the communication range of the mesh network is elastic because the breadth or scope (i.e., distance spanned) of the mesh network's communication range may be defined by the node that is located a greatest distance from the primary node, yet which is still within the communication range of another node (i.e., a node configured as a secondary node) in the mesh network. In this manner, the coverage area of the mesh network may be asymmetric and change over time based on the locations of the packages to which the nodes correspond as the packages are transported.

Continuing at block 416, an indication of the first device is received, wherein the indication includes location data for the first package, and indicates that the first device has not detected at least one of the second device or the third device over the mesh network. At block 418, the method 400 determines that the first device and the at least one of the second device or the third device are not concurrently located at a first location in a shipping chain based on the indication of the first device.

In further embodiments, based on determining that the first device and the at least one of the second device or the third device are not concurrently located at the first location, the method 400 may communicate computer instructions to an external device to initiate detection of the at least one of the second device or the third device in order to locate the at least one of the second package or the third package. For example, the computer instructions may be used by the external device and/or by one or more primary nodes or secondary nodes of another proximate in-range mesh network to “locate” the missing package associated with the second or third devices that is/are determined to be missing or misplaced as not concurrently received at the first location with the first package. Additionally or alternatively, based on determining that the first device and the at least one of the second device or the third device are not concurrently located at the first location in the shipping chain, the method 400 may communicate a notification that indicates the at least one of the second package or the third package were not concurrently received at the first location with the first package. In one embodiment, based on determining that the first device and the at least one of the second device or the third device are not concurrently located at the first location in the shipping chain, the method 400 may communicate an instruction to hold the first package at the first location. In some embodiments, a subsequent indication may be received that indicates the at least one of the second package or the third package has been located based on a detection of the at least one of the second device or the third device, in accordance with the method.

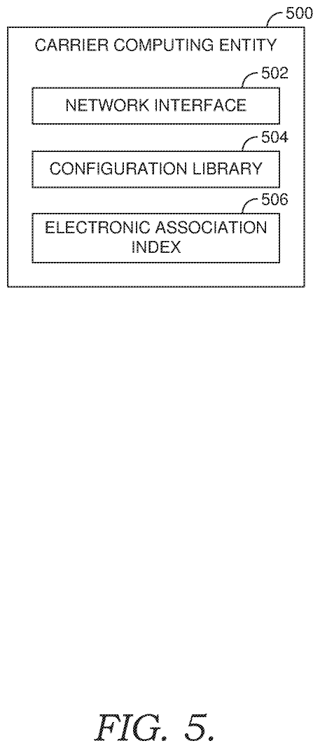

Turning to FIG. 5, a diagram is presented with regard to operations of a carrier computing device 500, in accordance with embodiments. It will be understood that the previous discussion of the environment 100 and methods 200 to 400 may be applicable to aspects of the carrier computing device 500 of FIG. 5. In embodiments, the carrier computing device 500 is a computing device for communicating over a wireless network, similar to the computing device 102 discussed with regard to FIG. 1. In some embodiments, the carrier computing device 500 operates in a distributed environment. For each of the operations discussed below, it will be understood from this description that the carrier computing device 500 may perform these operations automatically or on command, at different times or concurrently, and for any number of multi-package shipments in an on-going manner.

In embodiments, the carrier computing device 500 comprises one or more computer-readable storage media storing instructions that are executable by a processor to monitor a multi-package shipment. The carrier computing device 500 may comprise a network interface 502. In an embodiment, the carrier computing device 500 may connect to one or more networks using the network interface 502. An example of a network is a telecommunications network, a Wi-Fi network, and/or a stationary mesh network (e.g., within a fulfillment center). In some embodiments, the carrier computing device 500 may receive a shipping record, for example, using the network interface 502, for each of a plurality of multi-package shipments in the packing, shipping, and delivery chain. Alternatively, the carrier computing device 500 may generate shipping records. In either case, the carrier computing device 500 may receive and/or generate shipping labels for multi-package shipments based on the shipping records or shipment manifests previously described. In various embodiments, the shipping record or shipment manifest, whether generated or received by the carrier computing device 500, may be associated with one or more orders or invoices, and/or may specify one or more items (or components of the item) to be shipped using the multi-package shipment. The shipping record may indicate or specify that the one or more items are to be shipped to a user utilizing a plurality of packages, in some embodiments. In an embodiment, the shipping record corresponds to a shipment manifest, as previously described.

For each of a plurality of multi-package shipments in the packing, shipping, and delivery chain, for example, the carrier computing device 500 may receive one or more indications of devices, via the network interface 502. Using the one or more indications, for example, the carrier computing device 500 may identify that a particular device has specific communication ranges and may designate that particular device to be a first device acting a primary node for a mesh network, for a specific multi-package shipment. Using the one or more indications, the carrier computing device 500 may identify that other devices have specific communication ranges and may designate the other devices to act as second nodes in the mesh network, for the specific multi-package shipment.

Based on these designations, carrier computing device 500 may generate one or more device configuration files, where the one or more configuration files are used to specially configure and control or manage behavior of the first device and additional devices within the mesh network. In some embodiments, the carrier computing device 500 may access a configuration library 504 storing configuration files, whether remotely stored or locally stored in a database, in order to identify specific computer-readable instructions in the configuration files that the carrier computing device 500 may use, alone or in any combination with other configuration files, to specially configure the devices in the mesh network. The configuration library 504 may further include drivers for specific types of devices, specific device models, and/or specific software versions.

The carrier computing device 500 may push computer-readable instructions or rules to the first device, wherein automatic execution of the computer-readable instructions by a processor of the first device configures the first device to act as a primary node in the mesh network that is being created. Additionally, in some embodiments, a portion of the computer-readable instructions or rules that are pushed to the first device are pushed from the first device to the additional devices, wherein automatic execution of the computer-readable instructions by a processor of the additional devices configure the additional devices to act as secondary nodes in the mesh network that is being created.

The computer-readable instructions may specify how often a particular device (e.g., acting as a primary node or a secondary node) is to issue a signal of presence over the mesh network, how often a primary node is to anticipate receiving a signal of presence from other devices over the mesh network, timeout intervals, device standby or sleep mode intervals that are responsive to location information, speed information, and/or environmental information, which of one or more sensors of a device acting as a primary node are to be utilized, specify the type and kind of information to be captured by each of the one or more sensors, how often to capture information from sensors, and how often a device acting a primary node is configured to send a signal over an external network for receipt by a carrier computing device 500 or another device (e.g., a device that automatically scans, reads, or detects other devices, shipping labels, and/or mesh networks) that communicates with the carrier computing device 500. For example, in some embodiments, a first and/or second device acting as nodes in a mesh network may automatically begin operating a power-saving standby or sleep mode in response to the first and/or second device determining that, based on one or more of acceleration, location, temperature, atmospheric pressure, or maintained speed detected by one or more sensors of the device(s), the first and/or second devices are predicted to be traveling as air cargo. In one example, a first and/or second device acting as nodes in a mesh network may automatically disable long-range wireless communications in response to the first and/or second device determining that, based on one or more of acceleration, location, temperature, atmospheric pressure, or maintained speed detected by one or more sensors of the device(s), the first and/or second devices are predicted to be traveling as air cargo. In yet another example, a first and/or second device acting as nodes in a mesh network may automatically enter a standby/sleep mode and/or may disable long-range wireless communications in response to the first and/or second device determining that, based on identification of a nearby external device which is physically and/or electronically associated with an airplane or other vehicle for long-distance transport (i.e., within a predefined distance or proximity that is measurable by the node based on receipt of wireless communications and/or based on data/information contained in the wireless communications), the first and/or second devices are predicted to be entering a “leg” of transport during which power can be conserved and/or communications of the mesh network can be minimized as the packages are predicted to be physically traveling together for that particular leg of transport with a reduced occurrence of package loss based on the prediction that the packages are loaded/being loaded onto the airplane or vehicle.

The specific configuration rules may be tailored or customized to reflect the number, type, and kind of sensor(s) present in the device acting as a primary node, and/or may be tailored or customized to reflect the type and kind of goods being shipped (e.g., configure the device to capture shock data for a multi-package shipment containing fragile glassware, configure the device to capture temperature and/or humidity data for a multi-package shipment containing temperature-sensitive goods that may be chemically compromised when frozen or overheated, configure the device to capture humidity, temperature, and shock data for a multi-package shipment containing high-precision goods). It will be understood from this discussion that the configuration rules are merely examples and should not be construed as limiting, as further configurations and customization of configurations are contemplated to be within the scope of this disclosure. The carrier computing device 500 may perform the identifications, designations, and push-configurations discussed above automatically and concurrently for any number of multi-package shipments.

Once configured, the mesh network may automatically become active. Alternatively, the carrier computing device 500 may include, within the configuration files, a timer, a clock, or other trigger (e.g., location) that automatically activates the mesh network at a subsequent date or time from the configuration push.

In embodiments, and as previously described, the carrier computing device 500 may electronically link each device in a multi-package shipment to separate shipping labels (e.g., including a 1Z code). The carrier computing device 500 may store the electronic links in an electronic association index 506, as shown in FIG. 5. The electronic association index 506 may be configured to store links created between a shipping label, one or more portions of the shipping label, a unique identifier for a specific multi-package shipment, shipment manifest for a specific multi-package shipment, a shipping record for a specific multi-package shipment, a unique device identifier, and/or configuration rules for a unique device identifier. In one example, the electronic association index 506 may be configured to store links created between a 1Z code that is specific to one package and a unique device identifier. In embodiments, carrier computing device 500 may receive a confirmation when the devices for a multi-package shipment are co-located with corresponding packages and/or when the plurality of shipping labels are attached to the corresponding packages. Once the devices are associated with shipping labels and are co-located with corresponding packages for a multi-package shipment, the carrier computing device 500 may begin monitoring the multi-package shipment, for example, based on one or more indications sent by the device that is acting as the primary node in the mesh network. For example, the carrier computing device 500 may receive, using the network interface 502, an indication directly from the first device, and/or an indication of the first device as the first device is or was detected or scanned by another device in communication with the carrier computing device 500. In one example, the indication may specify location and/or environment data (e.g., captured via sensors) of a package that is co-located with the device acting as the primary node. Additionally, the indication may indicate that the first device acting as the primary node has detected, at a particular date and time (e.g., timestamp) using the mesh network, that a portion or all of the packages in the multi-package shipment are present based on detection of the presence of the additional devices that correspond to those packages, for example. In another example, the indication may indicate that the first device acting as the primary node has detected, at a particular date and time (e.g., timestamp) using the mesh network, that at least one of the packages in the multi-package shipment is not present based on a failure to detect the presence of at least one of the additional devices that corresponds to said package. As previously discussed, the unique device identifiers may be used by the carrier computing device 500 to specifically identify which exact package in a multi-package shipment is present or is not present. Indications may be sent by the device acting as a primary node continuously, intermittently, periodically, at predefined locations, dates, or times, for example, in a shipment schedule, as specified by a consignee, consignor, and/or a carrier. Based on the on-going nature of the receipt of indications from the device or of the device acting a primary node, the carrier computing device 500 monitors and tracks the multi-package shipment. As mentioned above, the carrier computing device 500 concurrently monitors and tracks any number of multi-package shipments in this way.

Based on the indications received, the carrier computing device 500 may determine whether the packages in a particular multi-package shipment are traveling together based on location data, or have experienced environmental changes (e.g., speed, shock, temperature) based on environment data. In some embodiments, the carrier computing device 500 may reference the electronic association index 506 when determining whether a particular package is present based on one or more unique device identifiers received via the indication of the device acting as the primary node. When a package in a multi-package shipment is not present with the rest of the packages in the group, the carrier computing device 500 may generate and communicate an alert, notification, or communication to another device, to a consignee, a consignor, a carrier, and/or a customs agent, for example. The notification, for example, may specify that a package is missing, misplaced, and/or delayed, and further may specifically indicate the exact package that is not present.

Accordingly, the device acting as the primary node directly monitors each and every one of the packages in a multi-package shipment using the mesh network to detect the other devices acting as secondary nodes in the mesh network. Then, the carrier computing device 500 receives indications from the primary node over another network so that the carrier computing device 500 monitors each and every one of the packages in a multi-package shipment through the device acting as the primary node. The carrier computing device 500, therefore, gains high resolution visibility of every package in a multi-package shipment, end-to-end within a packing, shipping, and delivery chain.

In contrast the embodiments discussed herein, other technologies required that each and every package be optically scanned in order to determine the presence of a package. Embodiments herein obviate the technological need for optically scanning or directly detecting each and every package, as the device acting a primary node provides, to the carrier computing device, a detailed account of the location and environment of a portion or all of the packages in the group by leveraging the mesh network.

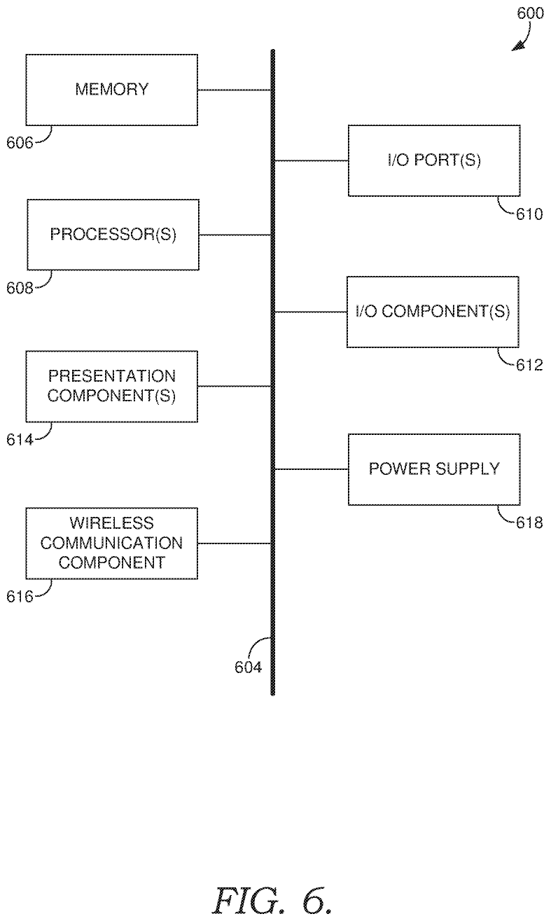

Turning to FIG. 6, it depicts a block diagram of a computing device 600 suitable to implement embodiments of the present invention. It will be understood by those of ordinary skill in the art that the computing device 600 is just one non-limiting example of a suitable computing device and is not intended to limit the scope of use or functionality of the present invention. Similarly, the computing device 600 should not be interpreted as imputing any dependency and/or any requirements with regard to each component and combination(s) of components illustrated in FIG. 6. It will be appreciated by those having ordinary skill in the art that the connections illustrated in FIG. 6 may comprise other methods, hardware, software, and/or devices for establishing a communications link between the components, devices, systems, and entities. Although the connections are depicted using one or more solid lines, it will be understood by those having ordinary skill in the art that the connections of FIG. 6 may be hardwired or wireless, and may use intermediary components that have been omitted or not included in FIG. 6 for simplicity's sake. As such, the absence of components from FIG. 6 should be not be interpreted as limiting the present invention to exclude additional components and combination(s) of components. Moreover, though devices and components are represented in FIG. 6 as singular devices and components, it will be appreciated that some embodiments may include a plurality of the devices and components such that FIG. 6 should not be considered as limiting the number of a devices or components.

Continuing, the computing device 600 may be in the form of a server, in some embodiments. Although illustrated as one component in FIG. 6, the present invention may utilize a plurality of local servers and/or remote servers in the computing device 600. The computing device 600 may include components such as a processing unit, internal system memory, and a suitable system bus for coupling to various components, including a database or database cluster. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The computing device 600 may include or may have access to computer-readable media. Computer-readable media may be any available media that may be accessed by server. Computer-readable media may include one or more of volatile media, nonvolatile media, removable media, or non-removable media. By way of a non-limiting example, computer-readable media may include computer storage media and/or communication media. Non-limiting examples of computer storage media may include one or more of volatile media, nonvolatile media, removable media, or non-removable media, may be implemented in any method and/or any technology for storage of information, such as computer-readable instructions, data structures, program modules, or other data. In this regard, non-limiting examples of computer storage media may include Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage device, or any other medium which may be used to store information and which may be accessed by the server. Generally, computer storage media is non-transitory such that it does not comprise a signal per se.

Communication media may embody computer-readable instructions, data structures, program modules, and/or other data in a modulated data signal, such as a carrier wave or other transport mechanism. Communication media may include any information delivery media. As used herein, the term “modulated data signal” refers to a signal that has one or more of its attributes set or changed in such a manner as to encode information in the signal. Non-limiting examples of communication media may include wired media, such as a wired network connection, a direct-wired connection, and/or a wireless media, such as acoustic, radio frequency (RF), infrared, and other wireless media. Combinations of any of the above also may be included within the scope of computer-readable media.

Continuing with FIG. 6, the a block diagram of a computing device 600 suitable for providing packing instructions is provided, in accordance with an embodiment of the technology. It should be noted that although some components depicted in FIG. 6 are shown in the singular, they may be plural, and the components may be connected in a different, including distributed, configuration. For example, computing device 600 may include multiple processors and/or multiple radios. As shown in FIG. 6, computing device 600 includes a bus 604 that may directly or indirectly connect different components together, including memory 606 and a processor 608. In further embodiments, the computing device 600 may include one or more of an input/output (I/O) port 610, I/O component 612, presentation component 614, or wireless communication component 616, such as a radio transceiver. The computing device 600 may be coupled to a power supply 618, in some embodiments.

Memory 606 may take the form of the memory components described herein. Thus, further elaboration will not be provided here, but it should be noted that memory 606 may include any type of tangible medium that is capable of storing information, such as a database. A database may include any collection of records, data, and/or other information. In one embodiment, memory 606 may include a set of computer-executable instructions that, when executed, facilitate various functions or steps disclosed herein. These instructions will variously be referred to as “instructions” or an “application” for short. Processor 608 may actually be multiple processors that may receive instructions and process them accordingly. Presentation component 614 may include a display, a speaker, a screen, a portable digital device, and/or other components that may present information through visual (e.g., a display, a screen, a lamp, a light-emitting diode (LED), a graphical user interface (GUI), and/or even a lighted keyboard), auditory (e.g., a speaker), haptic feedback, and/or other tactile cues. Wireless communication component 616 may facilitate communication with a network as previously described herein. Additionally or alternatively, the wireless communication component 616 may facilitate other types of wireless communications, such as Wi-Fi, WiMAX, LTE, Bluetooth, Zigbee, and/or other communications, such as VoIP. In various embodiments, the wireless communication component 616 may be configured to concurrently support multiple technologies.

I/O port 610 may take a variety of forms. Exemplary I/O ports may include a USB jack, a stereo jack, an infrared port, a firewire port, and/or other proprietary communications ports. I/O component 612 may comprise one or more keyboards, microphones, speakers, touchscreens, and/or any other item useable to directly or indirectly input data into the computing device 600. Power supply 618 may include batteries, fuel cells, and/or any other component that may act as a power source to supply power to computing device 600 or to other components.

Although internal components of the computing device 600 are not illustrated for simplicity, those of ordinary skill in the art will appreciate that internal components and their interconnection are present in the computing device 600 of FIG. 6. Accordingly, additional details concerning the internal construction of the computing device 600 are not further disclosed herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. One or more computer-readable storage media storing computer-usable instructions that when used by a computing device, cause the computing device to perform a method, the method comprising:
identifying a first device and a second device;
designating the first device to be a primary node in a mesh network;
designating the second device to be a secondary node in the mesh network, wherein the secondary node is monitored by the primary node over the mesh network;
electronically linking the first device to a first shipping label in a plurality of shipping labels, wherein the plurality of shipping labels corresponds to a multi- package shipment comprising a plurality of packages, and wherein the first device is attached to a first package in the multi-package shipment;
electronically linking the second device to a second shipping label in the plurality of shipping labels, wherein the second device is attached to a second package in the multi-package shipment;
monitoring the multi-package shipment based on the first device that is designated as the primary node that monitors the second device that is designated as the secondary node;
receiving an indication of the first device, wherein the indication includes location data for the first package and location data for the second package received by the first device over the mesh network from the second device; and
determining that the first device and the second device are concurrently located at a first location in a shipping chain based on the indication.

2. The method of claim 1 further comprising, based on determining that the first device and the second device are concurrently located at the first location, authorizing movement of the first package and the second package to a second location in the shipping chain.

3. The method of claim 1 further comprising, based on determining that the first device and the second device are concurrently located at the first location in the shipping chain, communicating a notification that confirms the first package and the second package were concurrently received at the first location in the shipping chain.

4. The method of claim 1 further comprising, based on determining that the first device and the second device are concurrently located at the first location in the shipping chain, communicating a notification that provides clearance for the first package and the second package to be moved to a second location in the shipping chain.

5. The method of claim 1, wherein the indication further indicates that the first device designated as the primary node has detected the second device over the mesh network, and wherein the location data for the first package and the location data for the second package concurrently correspond to the first location.

6. One or more computer-readable storage media storing computer-usable instructions that when used by a computing device, cause the computing device to perform a method, the method comprising:
identifying a first device and a second device;
designating the first device to be a primary node in a mesh network;
designating the second device to be a secondary node in the mesh network wherein the secondary node is monitored by the primary node over the mesh network;
electronically linking the first device to a first shipping label in a plurality of shipping labels, wherein the plurality of shipping labels correspond to a multi-package shipment comprising a plurality of packages, and wherein the first device is attached to a first package in the multi-package shipment;
electronically linking the second device to a second shipping label in the plurality of shipping labels, wherein the second device is attached to a second package in the multi-package shipment;
monitoring the multi-package shipment based on the first device designated as the primary node of the mesh network;
receiving an indication of the first device, wherein the indication includes location data of the first package, and indicates that the first device has not detected the second device over the mesh network; and
determining that the first device and the second device are not concurrently located at a first location in a shipping chain based on the indication of the first device.

7. The method of claim 6, wherein monitoring the multi-package shipment based on the first device designated as the primary node of the mesh network comprises receiving one or more notifications sent from the first device as the first package travels through the shipping chain, the one or more notifications including location data for the first package captured by the first device and location data for the second package sent by the second device to the first device over the mesh network.

8. The method of claim 6 further comprising, based on determining that the first device and the second device are not concurrently located at the first location, communicating computer instructions to an external device to locate the second package by initiating detection of the second device.

9. The method of claim 6 further comprising, based on determining that the first device and the second device are not concurrently located at the first location, communicating a notification that indicates the second package was not concurrently received at the first location with the first package.

10. The method of claim 6 further comprising, based on determining that the first device and the second device are not concurrently located at the first location, communicating a notification that indicates the second package is delayed.

11. The method of claim 6 further comprising, based on determining that the first device and the second device are not concurrently located at the first location, communicating an instruction to hold the first package at the first location for a defined period of time.

12. The method of claim 6, wherein the indication of the first device is received directly from the first device over an external network, or one or more sensors located at the first location that detect at least one of the mesh network or the first device.

13. One or more computer-readable storage media storing computer-usable instructions that when used by a computing device, cause the computing device to perform a method, the method comprising:
identifying a plurality of devices comprising at least a first device, a second device, and a third device;
designating the first device to be a primary node in a mesh network formed by the plurality of devices;
designating the second device and the third device to be secondary nodes in the mesh network, wherein the secondary nodes are monitored by the primary node over the mesh network;
electronically linking the first device to a first shipping label in a plurality of shipping labels, wherein the plurality of shipping labels correspond to a multi-package shipment comprising a plurality of packages, and wherein the first device is attached to a first package in the multi-package shipment;
electronically linking the second device to a second shipping label in the plurality of shipping labels, wherein the second device is attached to a second package in the multi-package shipment;
electronically linking the third device to a third shipping label in the plurality of shipping labels, wherein the third device is attached to a third package in the multi-package shipment;
monitoring the first package, the second package, and the third package of the multi-package shipment based on the first device designated as the primary node of the mesh network;
receiving an indication of the first device, wherein the indication includes location data for the first package, and indicates that the first device has not detected at least one of the second device or the third device over the mesh network; and
determining that the first device and the at least one of the second device or the third device are not concurrently located at a first location in a shipping chain based on the indication of the first device.

14. The method of claim 13 further comprising, based on determining that the first device and the at least one of the second device or the third device are not concurrently located at the first location, communicating computer instructions to an external device to initiate detection of the at least one of the second device or the third device in order to locate the at least one of the second package or the third package.

15. The method of claim 13 further comprising, based on determining that the first device and the at least one of the second device or the third device are not concurrently located at the first location in the shipping chain, communicating a notification that indicates the at least one of the second package or the third package were not concurrently received at the first location with the first package.

16. The method of claim 13 further comprising, based on determining that the first device and the at least one of the second device or the third device are not concurrently located at the first location in the shipping chain, communicating an instruction to hold the first package at the first location.

17. The method of claim 16 further comprising receiving a subsequent indication that indicates the at least one of the second package or the third package has been located based on a detection of the at least one of the second device or the third device.

18. The method of claim 13 further comprising receiving a notification that the mesh network formed by the first device, the second device, and the third device is active.

19. The method of claim 13 further comprising communicating rules to the first device designated as the primary node, wherein the rules configure the first device to operate as the primary node in the mesh network.

20. A system comprising:
one or more computer-readable storage media storing instructions that are executable by a processor to monitor a multi-package shipment by:
identifying a first device and a second device;
designating the first device to be a primary node in a mesh network, wherein the primary node communicates over the mesh network and an external network;
designating the second device to be a secondary node in the mesh network, wherein the secondary node is monitored by the primary node over the mesh network;
electronically linking the first device to a first shipping label in a plurality of shipping labels, wherein the plurality of shipping labels correspond to the multi-package shipment comprising a plurality of packages, and wherein the first device is attached to a first package in the multi-package shipment;
electronically linking the second device to a second shipping label in the plurality of shipping labels, wherein the second device is attached to a second package in the multi-package shipment;
monitoring the multi-package shipment based on the first device designated as the primary node that monitors the secondary node over the mesh network;
receiving an indication of the first device, wherein the indication includes location data for the first package and indicates that the first device has not detected the second device over the mesh network; and
determining that the first device and the second device are not concurrently located at a first location in a shipping chain based on the indication of the first device.
